(19) United States
(12) Patent Application Publication
(10) Pub. No.: US 2009/0086158 A1
(43) Pub. Date: Apr. 2, 2009

(54) Hinge for Glasses With Closing Block and Method to Obtain Said Hinge

(75) Inventor: Guido Medana, Valdobbiadene (Treviso) (IT)

Correspondence Address: YOUNG & THOMPSON, 209 Madison Street, Suite 500, ALEXANDRIA, VA, 22314, US

(73) Assignee: COMOTEC SA, Morez Cedex (FR)

(21) Appl. No.: 11/918,063

(22) PCT Filed: Aug. 18, 2005
(86) PCT No.: PCT/IB2005/052719

§ 371 Date: Oct. 9, 2007

(30) Foreign Application Priority Data
Apr. 6, 2005 (IT) MI2005A000572

(51) Int. Cl. G02C 5/22

(52) U.S. Cl. 351/153

(57) ABSTRACT

A glasses hinge and method to obtain said hinge is disclosed, of the type comprising a male portion (M) and a female portion (F), mutually connected by a small articulated pin (P), equipped with coupling surfaces, apt to define blocking positions while opening and closing, which are radial and, at least on one of the two portions, are obtained by removing material through mechanical machining.

The present invention relates to a hinge for glasses and to the method to obtain said hinge. In particular it refers to a hinge with a closing block for the temple bar.

As known, a variety of hinges exist in the eyewear sector which ensure hinging of the temple bars on the frame front-piece.

For some specific applications an articulated hinge for temple bars with a block for closing is required, i.e. a hinge equipped with means apt to establish a stop of the temple bar rotation while closing, in a desired position.

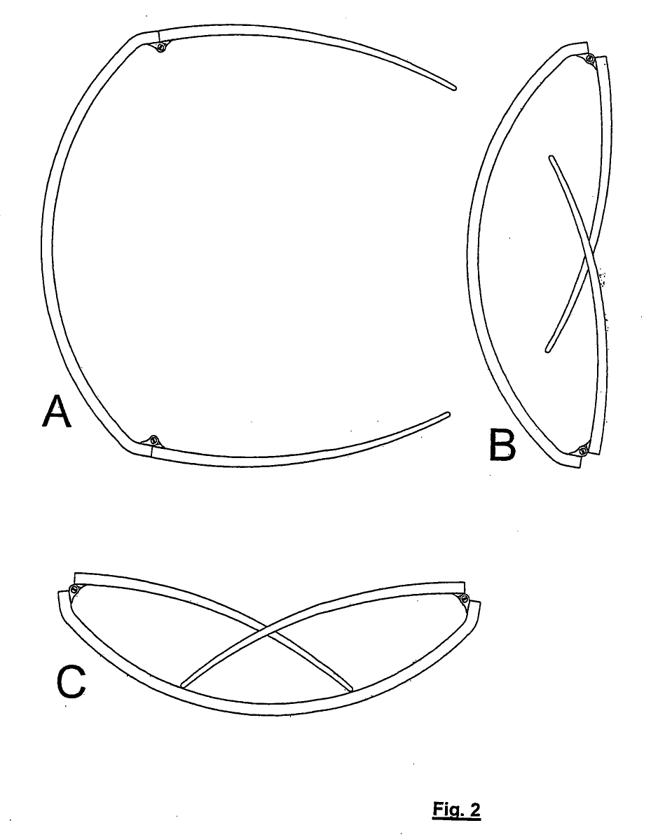

This feature has been required, especially over recent years, for the sunglasses market where—for aesthetic and design reasons—the frame has an extremely pronounced base curve, also called wrap-around. As a matter of fact, the salient characteristic of a wrap-around glasses frame is that of having particularly short temple bars, often coupled with small curved tips (the part which is in contact with the ears): by analysing these two features in the temple bars/frontpiece assembly, it can be noticed that the glasses appear to be endearing and very “clean”, in the open temple bars condition (FIG. 2A), but an inconvenience occurs in the closed temple bars condition, due to the fact that the outermost ends of the temple bars interfere (FIG. 2C) with the inner surface of the lenses causing, after a short while, permanent marks on the same.

To overcome this inconvenience, hinges with a block are hence employed, which prevent the temple bars from closing beyond a certain angle (FIG. 2B).

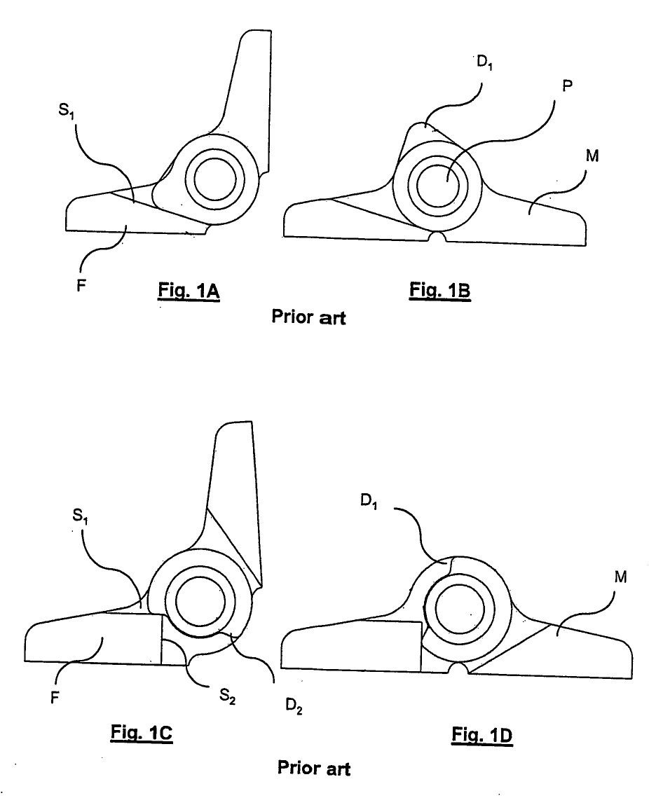

In FIGS. 1A-1D two known art solutions are shown in a longitudinal cross-section.

FIGS. 1A and 1B show the two extreme conditions (closed and opened) of a first solution comprising, as usual, a male portion M and a female portion F, mutually joined by a hinge pin P of any known type (for example a screw); it is clearly visible how the blocking function while closing (FIG. 1A) is obtained through a cam D1, protruding from the crown of the male portion M of the hinge, which interferes with a step surface S₁ obtained within the female portion of the hinge. The above-mentioned hinge works quite well, but has a significant disadvantage: the presence of cam D₁ may cause injury, since it protrudes towards the user's temples (FIG. 1B) when the glasses are worn.

FIGS. 1C and 1D show instead the two working conditions of another solution lacking the protruding cam. In this case, the crown or washer of the male portion M of the hinge is interrupted for a certain length and comprises two shaped shoulders D₁ and D₂, which consequently remain confined within the profile of the male portion of the hinge. These two shoulders, suitably distanced from each other, are intended to interfere with two mutually perpendicular abutments, S₁ and S₂ respectively, obtained on the female portion F of the hinge.

In this case, aesthetic cleanliness and safety for the wearer are preserved, whereas from a purely mechanical point of view restrictions apply. On one hand, as a matter of fact, the two shoulders D₁ e D₂, are very fragile and in case of accidental impacts or simply with intense use, the point of blocking while closing can be easily forced causing irreversible damage to the coupling profiles (it must be borne in mind that the material most often used for these hinges is nickel silver). On the other hand, since for the construction of male portions of the hinges, purpose-built profiles are needed, these solutions are decidedly more expensive than conventional ones.

The object of the present invention is hence that of providing a hinge with a blocking device and a method to obtain said hinge, which—in addition to being effective in their operation—offer a clean and streamlined appearance of the glasses, with no protrusions, guarantee total mechanical reliability and have limited costs.

Such object is achieved by means of a hinge and a method as described in their essential features in the accompanying main claims 1) and 4).

Other inventive aspects of the invention are described in the dependent claims.

Further features and advantages of the hinge according to the invention will in any case be clearer from the following detailed description of a preferred embodiment of the same, given by way of example and shown in the accompanying drawings, wherein:

FIGS. 1A and 1B, as already mentioned, are longitudinal cross-section views of known art hinges;

FIGS. 1C and 1D, as already mentioned, are longitudinal cross-section views of other known art hinges;

FIGS. 2A, 2B, and 2C are top plan views of a complete pair of eyeglasses with open and folded temple bars;

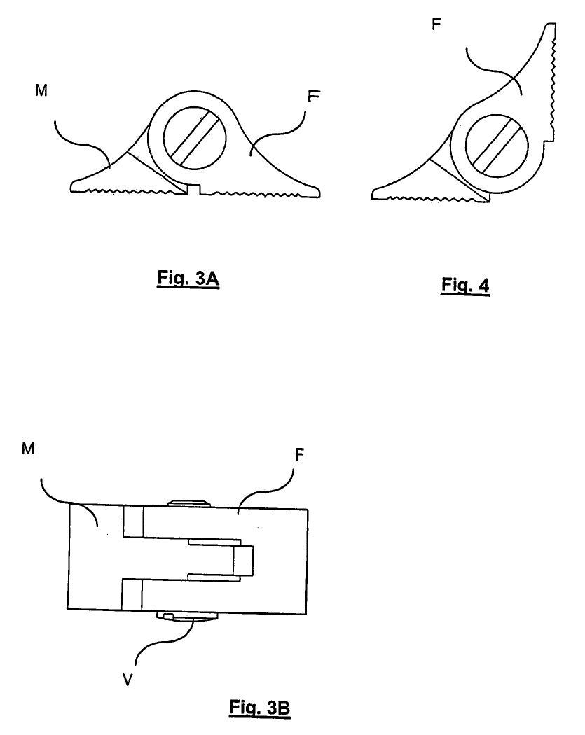

FIGS. 3A e 3B are side elevation and top plan views, respectively, of a hinge according to the invention in an open condition;

FIG. 4 is a view as in FIG. 3A with the hinge closed in its blocked condition;

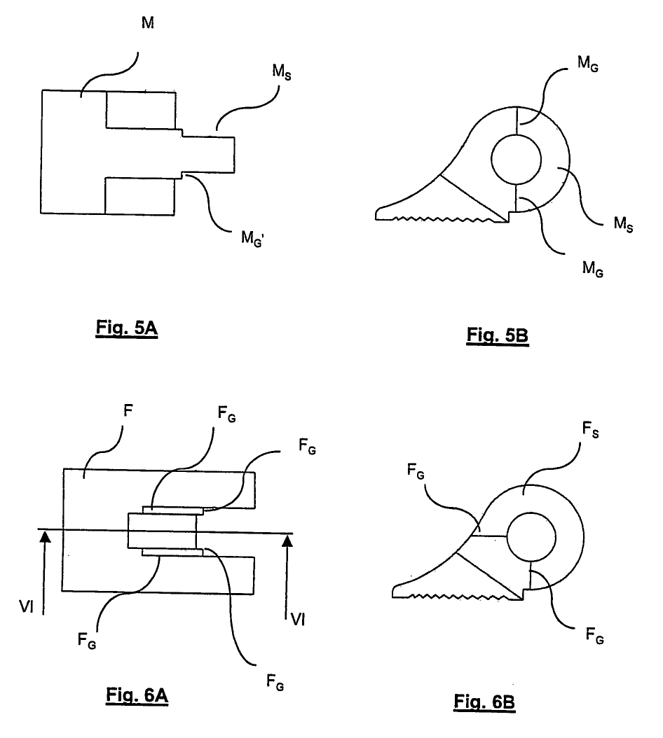

FIGS. 5A and 5B are top plan and side elevation views, respectively, of the male portion of the hinge according to the invention;

FIGS. 6A and 6B are top plan and cross-section views, respectively, the latter along line VI-VI, of the female portion of the hinge according to the invention; and

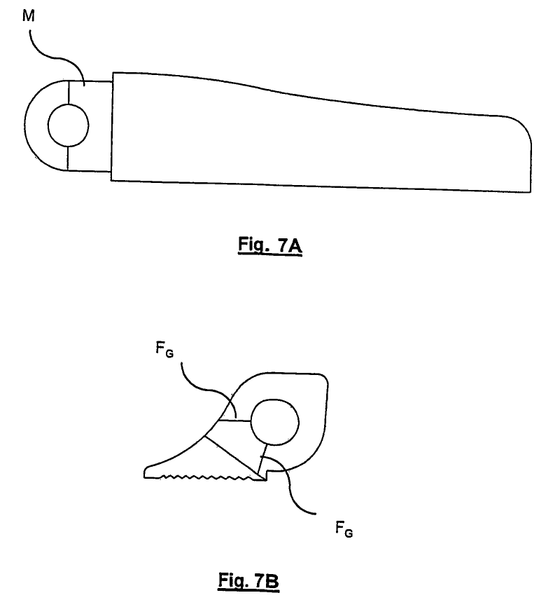

FIGS. 7A and 7B are side elevation views of a male and of a female portion of the hinge, respectively, according to another embodiment of the invention.

As is visible in FIGS. 3-4, in a manner known per se, a hinge consists of a male component M and of a female component F, the male component M entering between the two forks of the female one F (FIG. 3B), coupled through a hinge pin, such as a screw V.

According to the invention, the blocking system—while closing and opening the hinge—is established by means of radial planes obtained by machining the inner surface of the seat of the female portion of the hinge and the two outer surfaces of the male washer.

In particular, as can be seen in FIGS. 5A and 5B, a certain thickness is removed, for example 0.2 mm each side, from a 180° circular sector of the washer of male portion M (for example having a thickness of 1 mm), obtaining depressed surfaces M_{S} and radial steps or planes M_{G}.

In every other respect, the male portion of the hinge is identical to a standard hinge.

Similarly, inside the female portion of the hinge (FIGS. 6A and 6B), two opposite areas of a limited thickness are obtained on a 270° circular sector, always by material removal, so as to obtain steps or planes F_{G} and coupling surfaces F_{S}. As an example, and consistently with the above-reported indications, the female portion of the hinge may have a slot with minimum width of 0.6 mm, which is further widened to 1 mm overall in correspondence of the 270° sectors (following removal of a 0.2 mm thickness on each opposing side of the slot).

As can be noticed, the above mentioned planes F_{G} are mutually arranged at 90° but, in case different opening or closing angles are required, it is sufficient to arrange the same according to the required angular position.

According to the embodiment shown in FIGS. 7A and 7B, for example, the planes of the male portion of the hinge are always at 180° to each other, whereas the ones of the female portion of the hinge (FIG. 7B) are arranged according to an angle below 90°. In particular, the lower plane is tilted with respect to the vertical (in the drawing), so as to allow to open the temple bar beyond the standard opening angle, thereby achieving a structure suitable for a so-called “flex” hinge (equipped with elastic opposition means).

This feature can also be inverted between the male portion of the hinge and the female one, i.e. it is possible to provide a 90° angle between the planes of the female portion of the hinge and an angle smaller than 180° for the planes of the male portion of the hinge.

As can be understood, the solution suggested by the invention achieves the objects set forth in the preliminary remarks.

In particular, the hinge according to the invention allows to have blocking planes which lie fully within the hinge, therefore with no protruding parts.

Moreover, the process to establish said blocking system does not call for the implementation of specific profiles for the male portion of the hinge, but the blocking planes may be obtained from standard hinges by simple mechanical machining processes which can be introduced in an ordinary production process.

In the industrial process, the above-mentioned mechanical machining can be provided in the ordinary productive cycle and, with minimal changes to ordinary scheduling, it can be advantageously applied to components already being manufactured, thereby allowing to avoid significant investments both in terms of stock and of special profiles requiring dedicated equipment.

The reliability and accuracy of this hinge are guaranteed by double and planar couplings, rather than by single and cusp ones as was instead the case in the known art. The option of defining blocking planes on one side only is in any case preserved when the conditions to do so are provided, all to the advantage of manufacturing economy. Hence, should the size of the hinge and the material employed allow it, it is also possible to manufacture the invention by working one side of the hinges only, instead of both as described and shown in the drawings.

As we have seen, besides, the invention lends itself perfectly to being employed also with hinges equipped with flex movement.

It is intended, however, that the invention is not limited to the particular arrangements illustrated above, which represent only non-limiting examples of the scope of the invention, but that a number of variants are possible, all within the reach of a person skilled in the field, without departing from the scope of the invention as defined by the following claims.

1) A hinge for glasses, of the type comprising a male portion (M) and a female portion (F) , mutually connected by a small articulating pin (P), equipped with coupling surfaces (M_{G}, F_{G}) apt to define at least a position for blocking while closing, characterised in that said coupling surfaces (M_{G}, F_{G}) are radial with respect to the hinge axis and, at least on one of the two male or female portions, are obtained through material removal through mechanical machining.

2) The hinge as in claim 1), wherein said coupling surfaces are obtained on both opposing sides of a washer of the male portion (M).

3) The hinge as in claim 1), wherein said coupling surfaces also define a position of a block for closing.

4) The method to obtain a glasses hinge as in claim 1), wherein, once the two male and female portions of the hinge have been obtained from respective profiles (M, F), said coupling surfaces (M_{G}, F_{G}) are obtained radially by removing a thickness of material.

5) A pair of glasses of the type comprising a frame frontpiece and a pair of temple bars, characterised in that, at the hinging point of the temple bars to the frontpiece, hinges are provided as in claim 1.

6) The hinge as in claim 2), wherein said coupling surfaces also define a position of a block for closing.

7) The method to obtain a glasses hinge as in claim 2), wherein, once the two male and female portions of the hinge have been obtained from respective profiles (M, F), said coupling surfaces (M_{G}, F_{G}) are obtained radially by removing a thickness of material.

8) The method to obtain a glasses hinge as in claim 3, wherein, once the two male and female portions of the hinge have been obtained from respective profiles (M, F), said coupling surfaces (M_{G}, F_{G}) are obtained radially by removing a thickness of material.

9) A pair of glasses of the type comprising a frame frontpiece and a pair of temple bars, characterised in that, at the hinging point of the temple bars to the frontpiece, hinges are provided as in claim 2.

10) A pair of glasses of the type comprising a frame frontpiece and a pair of temple bars, characterised in that, at the hinging point of the temple bars to the frontpiece, hinges are provided as in claim 3.

11) A pair of glasses of the type comprising a frame frontpiece and a pair of temple bars, characterised in that, at the hinging point of the temple bars to the frontpiece, hinges are provided as in claim 4.

12) A pair of glasses of the type comprising a frame frontpiece and a pair of temple bars, characterised in that, at the hinging point of the temple bars to the frontpiece, hinges are provided as in claim 6.

13) A pair of glasses of the type comprising a frame frontpiece and a pair of temple bars, characterised in that, at the hinging point of the temple bars to the frontpiece, hinges are provided as in claim 7.

14) A pair of glasses of the type comprising a frame frontpiece and a pair of temple bars, characterised in that, at the hinging point of the temple bars to the frontpiece, hinges are provided as in claim 8.
